(19) United States
(12) Patent Application Publication
(10) Pub. No.: US 2006/0098737 A1
(43) Pub. Date: May 11, 2006

(54) Segment-based motion estimation

(75) Inventors: Ramanathan Sethuraman, Eindhoven (NL); Fabian Edgar Ernst, Eindhoven (NL); Patrick Peter Elisabeth Meuwissen, Eindhoven (NL); Harm Johannes Antonius Maria Peters, Eindhoven (NL); Rafael Peset Llopis, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/539,898

(22) PCT Filed: Nov. 20, 2003
(86) PCT No.: PCT/IB03/05474

§ 371 Date: Jun. 16, 2005

(51) Int. Cl. H04N 11/02; H04N 7/12; H04B 1/66; H04N 11/04

(52) U.S. Cl. 375/240.16; 375/240.24; 375/240.12

(57) ABSTRACT

A method to determine motion vectors for respective segments (S11-S14) of a segmented image (100) comprises: creating sets of candidate motion vectors for the respective segments (S11-S14); dividing the segmented image (100) into a grid of blocks (b11-b88) of pixels; determining for the blocks (b11-b88) of pixels which of the candidate motion vectors belong to the blocks (b11-b88), on basis of the segments (S11-S14) and the locations of the blocks (b11-b88) within the segmented image (100); computing partial match errors for the blocks (b11-b88) on basis of the determined candidate motion vectors and on basis of pixel values of a further image (102); combining the partial match errors into a number of match errors per segment; selecting for each of the sets of candidate motion vectors respective candidate motion vectors on basis of the match errors; and assigning the selected candidate motion vectors as the motion vectors for the respective segments (S11-S14).

The invention relates to a method of segment-based motion estimation to determine motion vectors for respective segments of a segmented image.

The invention further relates to a motion estimation unit for estimating motion vectors for respective segments of a segmented image.

The invention further relates to an image processing apparatus comprising:

a segmentation unit for segmenting an input image into a segmented image; and

such a motion estimation unit for estimating motion vectors for respective segments of the segmented image.

Segment-based motion estimation is an important processing step in a number of video processing algorithms, e.g. 2D into 3D content conversion, video coding, scan rate conversion, tracking of objects for security purposes, and picture quality improvement. Whereas, current motion-estimation algorithms are mostly block-based, segment-based motion estimation has the potential for higher accuracy since motion vectors can be computed pixel-accurate. Given a segmentation of an image, e.g. video frame, a sketch of the segment-based motion estimation is as follows: select candidate motion vectors for each segment, evaluate each of the candidate motion vectors per segment by means of computing respective match errors and select the best matching candidate motion vectors per segment on basis of the evaluation.

Since segments can be of arbitrary shape and size, a straight-forward implementation of this algorithm will result in the inefficient use of the memory bandwidth. Typically, pixel values of a bounding box of the segment under consideration are accessed from memory. This would result in inefficient use of memory bandwidth since not all the pixels within the bounding box are part of the segment under consideration.

It is an object of the invention to provide a method of the kind described in the opening paragraph which is based on a relatively efficient memory bandwidth usage.

This object of the invention is achieved in that the method comprises:

creating sets of candidate motion vectors for the respective segments;

dividing the segmented image into a grid of blocks of pixels;

determining for the blocks of pixels which of the candidate motion vectors belong to the blocks, on basis of the segments and the locations of the blocks within the segmented image;

computing partial match errors for the blocks on basis of the determined candidate motion vectors and on basis of pixel values of a further image;

combining the partial match errors into a number of match errors per segment;

selecting for each of the sets of candidate motion vectors respective candidate motion vectors on basis of the match errors; and

assigning the selected candidate motion vectors as the motion vectors for the respective segments.

An important aspect of the invention is the overlaying of a grid of blocks on a segmented image and doing an efficient motion estimation per block. After the motion estimations per block have been performed, the results per segment are computed by means of accumulation of the results per block. Hence, memory access and computation of partial match errors are block-based. These features enable an easy implementation of the segment-based motion estimation algorithm. An other advantage of the method according to the invention is that massive parallelism can be achieved, since a segmented image can be split into several groups of blocks, processing the blocks of the various groups can be done in parallel. This feature can steer numerous parallel solutions (VLIWs, ASICs) for this method.

An embodiment of the method according to the invention further comprises:

splitting each block of a portion of the blocks into respective groups of pixels on basis of the segments and the locations of the blocks within the segmented image, each block of the portion of the blocks overlapping with multiple segments;

determining for the groups of pixels which of the candidate motion vectors belong to the groups of pixels, on basis of the segments and the locations of the groups of pixels within the segmented image;

computing further partial match errors for the groups of pixels on basis of the determined candidate motion vectors and on basis of the pixel values of the further image; and

combining the partial match errors and the further partial match errors into a number of match errors per segment.

If a block overlaps with multiple segments, then the block is split into a number of groups of pixels, with the number of groups being equal to the number of segments with which the block overlaps. For each of the groups of a block a partial match error is being calculated. That means e.g. that if a block overlaps with four segments, then four groups of pixels are established. For each of the four groups the corresponding candidate motion vectors are evaluated. So, four partial match errors are computed for that block. Eventually these four partial match errors are accumulated with the partial match errors belonging to the respective segments. An advantage of this embodiment according to the invention is the accuracy of the evaluation results.

In another embodiment of the method according to the invention, determining for the blocks of pixels which of the candidate motion vectors belong to the blocks, is based on the amount of overlap between segments and the blocks within the segmented image. In this embodiment according to the invention, the number of evaluated candidate motion vectors for a block is not linear related to the number of overlapping segments. E.g. suppose that a block overlaps with two segments and that for each of these segments there are five candidate motion vectors, then a maximum of ten candidate motion vectors could be evaluated for that block. However, if the amount of overlap with one of the segments is relatively small, e.g. less than 10% of the pixels of the block then evaluation of the candidate motion vectors for that segment could be skipped for that block. That means that only the candidate motion vectors of the other segment, with a relatively large amount of overlap are evaluated: five in this example. For this evaluation two different approaches can be applied. First, the candidate motion vectors are evaluated for all pixels of the block, including the pixels which belong to the other segment. Second, the candidate motion vectors are evaluated for only a group of pixels comprised by the pixels of the block, excluding the pixels which belong to the other segment. An advantage of this embodiment according to the invention is that the number of computations is limited compared with the other embodiment as described above.

In an embodiment of the method according to the invention, a first one of the partial match errors corresponds with the sum of differences between pixel values of the segmented image and further pixel values of the further image. Preferably the partial match error corresponds to the Sum of Absolute Difference (SAD). With pixel value is meant the luminance value or the color representation. An advantage of this type of match error is that it is robust, while the number of calculations to compute the match error is relatively small.

Preferably a block of pixels comprises 8*8 or 16*16 pixels. This format is a often used format. An advantage is compatibility with off-the-shelf hardware.

An embodiment of the method according to the invention further comprises:

determining a final motion vector on basis of a first one of the motion vectors, being assigned to a first one of the segments, and on basis of a particular motion vector, being assigned to a further segment of a further segmented image, the segmented image and the further segmented image being both part of a single extended image, the first one of the segments and the further segment being both part of a single segment which extends over the segmented image and the further segmented image; and

assigning the final motion vector to the first one of the segments.

In other words, this embodiment according to the invention performs a kind of post-processing to combine the results of a number of sub-images, i.e. parts of an extended image. Another way of looking at it, is that an extended image is processed in a number of stripes of blocks or tiles of blocks to find intermediate motion vectors for sub-segments and that eventually these intermediate motion vectors are used to determine the appropriate motion vectors for the respective segments of the extended image. An advantage of this embodiment is a further efficiency increase of memory bandwidth usage.

Preferably the first one of the motion vectors is assigned as the final motion vector if a first size of the first one of the segments is larger than a second size of the further segment, and the particular motion vector is assigned as the final motion vector if the second size is larger than the first size. Alternatively, the final motion vector is determined by means of computing an average of the two motion vectors, i.e. the first one of the motion vectors and the particular motion vector. Preferably, this is a weighted average on basis of the first and second size.

It is a further object of the invention to provide a motion estimation unit of the kind described in the opening paragraph which is based on a relatively efficient memory bandwidth usage.

This object of the invention is achieved in that the motion estimation unit comprises:

creating means for creating sets of candidate motion vectors for the respective segments;

dividing means for dividing the segmented image into a grid of blocks of pixels;

determining means for determining for the blocks of pixels which of the candidate motion vectors belong to the blocks, on basis of the segments and the locations of the blocks within the segmented image;

computing means for computing partial match errors for the blocks on basis of the determined candidate motion vectors and on basis of pixel values of a further image;

combining means for combining the partial match errors into a number of match errors per segment;

selecting means for selecting for each of the sets of candidate motion vectors respective candidate motion vectors on basis of the match errors; and

assigning means for assigning the selected candidate motion vectors as the motion vectors for the respective segments.

It is a further object of the invention to provide an image processing apparatus of the kind described in the opening paragraph comprising a motion estimation unit which is based on a relatively efficient memory bandwidth usage.

This object of the invention is achieved in that the motion estimation unit is arranged to perform the method as claimed in claim 1. An embodiment of the image processing apparatus according to the invention comprises processing means being controlled on basis of the motion vectors. The processing means might support one or more of the following types of image processing:

Video compression, i.e. encoding or decoding, e.g. according to the MPEG standard.

De-interlacing: Interlacing is the common video broadcast procedure for transmitting the odd or even numbered image lines alternately. De-interlacing attempts to restore the full vertical resolution, i.e. make odd and even lines available simultaneously for each image;

Image rate conversion: From a series of original input images a larger series of output images is calculated. Output images are temporally located between two original input images; and

Temporal noise reduction. This can also involve spatial processing, resulting in spatial-temporal noise reduction.

The image processing apparatus optionally comprises a display device for displaying output images. The image processing apparatus might e.g. be a TV, a set top box, a VCR (Video Cassette Recorder) player, a satellite tuner, a DVD (Digital Versatile Disk) player or recorder.

Modifications of the method and variations thereof may correspond to modifications and variations thereof of the motion estimation unit described.

These and other aspects of the method, of the motion estimation unit and of the image processing apparatus according to the invention will become apparent from and will be elucidated with respect to the implementations and embodiments described hereinafter and with reference to the accompanying drawings, wherein:

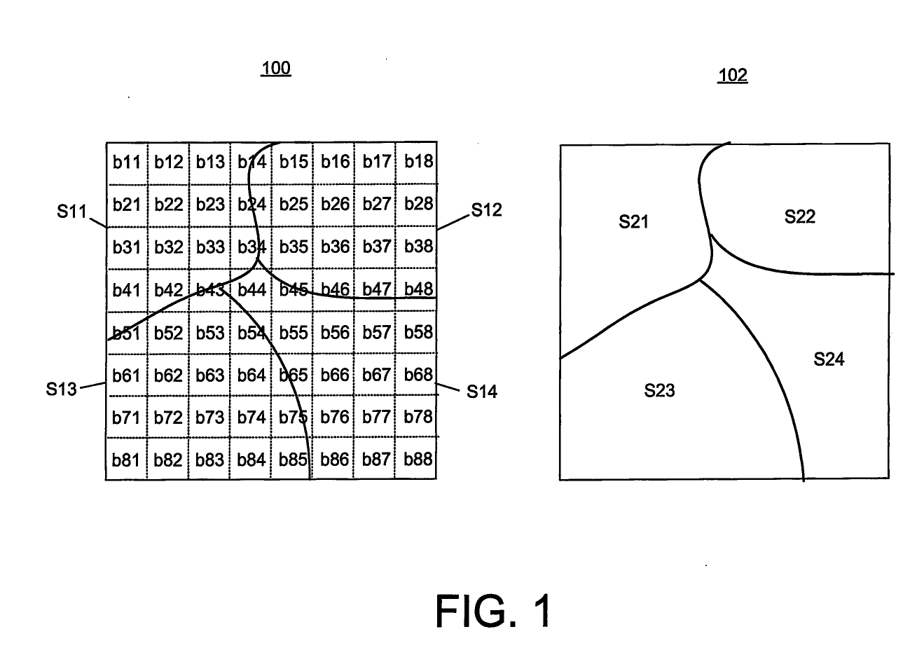

FIG. 1 schematically shows two consecutive segmented images;

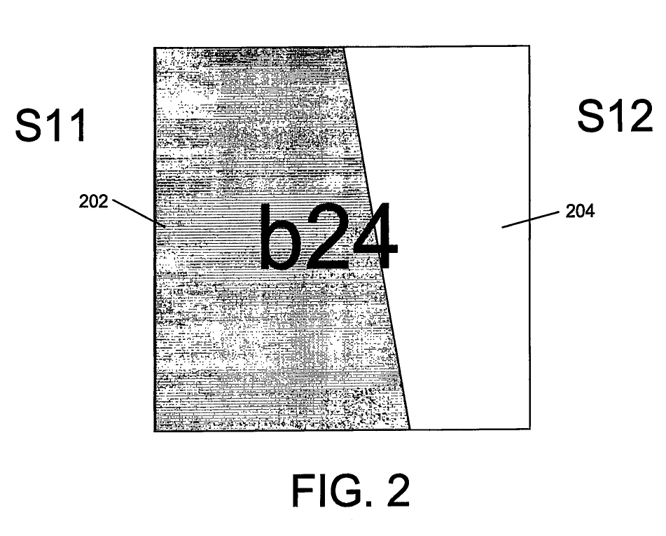

FIG. 2 schematically shows a detail of FIG. 1;

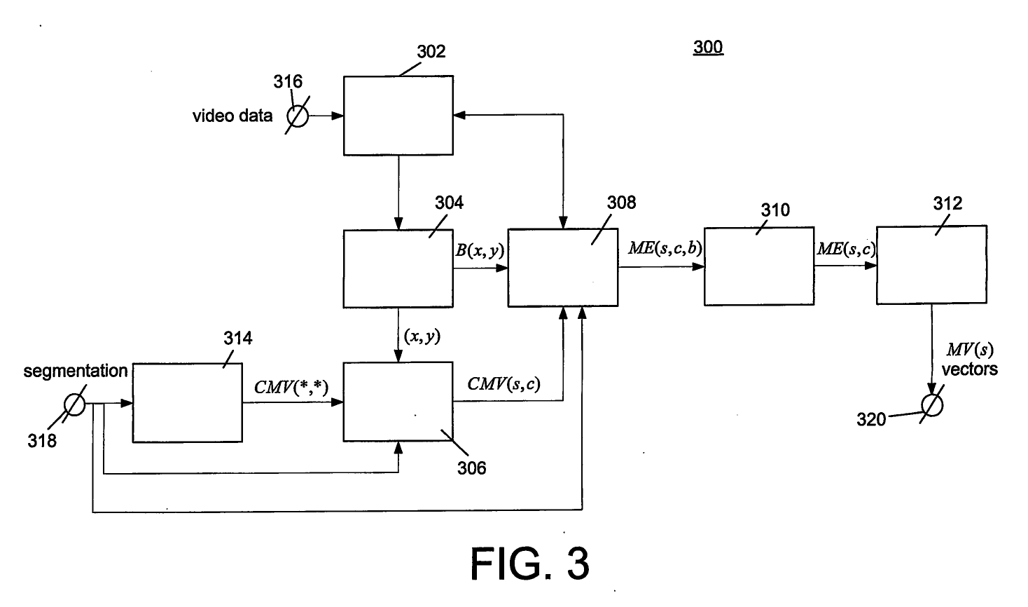

FIG. 3 schematically shows an embodiment of the motion estimation unit according to the invention;

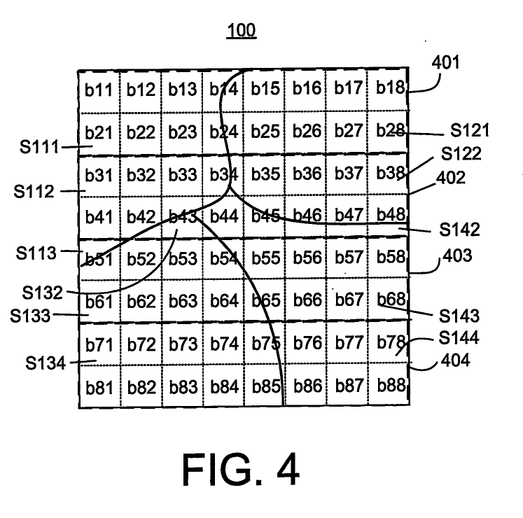

FIG. 4 schematically shows one of the segmented images of FIG. 1 and the four sub-images forming that segmented image; and

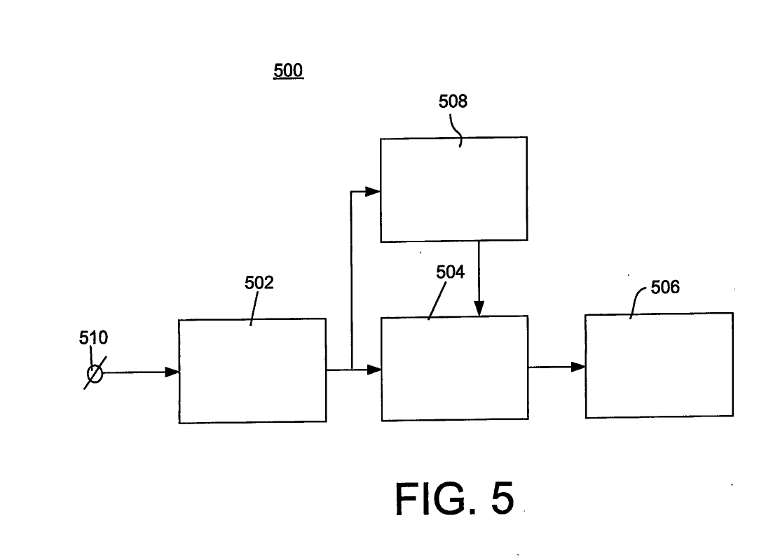

FIG. 5 schematically shows an image processing apparatus according to the invention.

Same reference numerals are used to denote similar parts throughout the Figures.

FIG. 1 schematically shows two consecutive segmented images 100 and 102. The first image 100 comprises four segments, S11, S12, S13 and S14. The second image 102 also comprises four segments S21, S22, S23 and S24. Segment S11 of the first image 100 corresponds to segment S21 of the second image 102. Segment S12 of the first image 100 corresponds to segment S22 of the second image 102. Segment S13 of the first image 100 corresponds to segment S23 of the second image 102. Segment S14 of the first image 100 corresponds to segment S24 of the second image 102. Because of movement, e.g. movement of the camera related to the objects in a scene being image, the various segments are shifted related to the image coordinate system. These shifts can be estimated by means of motion estimation. That means that motion vectors MV(1), MV(2), MV(3) and MV(4) are estimated which describe the relations between the segments S11, S12, S13 and S14 and the segments S21, S22, S23 and S24, respectively. The motion estimation is based on evaluation of candidate motion vectors for each of the segments CMV(s,c), with s representing the segments and c representing the candidates per segment. For each of the candidate motion vectors CMV(s,c) of the segments, a match error ME(s,c) is computed. Per segment the candidate motion vector is selected with the lowest match error. This selected candidate motion vector is assigned as the motion vector MV(s) for the corresponding segment.

The computation of the match errors ME(s,c) according to the invention is based on the computation of a number of partial match errors ME(s,c,b). The segmented image is divided into multiple blocks with mutually equal dimensions. For each of these blocks it is checked with which of the segments of the image it overlaps. Based on the overlap, the appropriate candidate motion vectors are selected. On basis of the candidate motion vectors and the coordinates of the blocks the corresponding pixel values of the second image 102 are accessed to be compared with the pixel values of the block. In this way block-by-block, e.g. in a row scanning scheme or column scanning scheme, the partial match errors ME(s,c,b) are computed. Optionally, parallel processing is applied to compute multiple partial match errors ME(s,c,b) simultaneously. The partial match errors ME(s,c,b) are accumulated per segment as specified in Equation 1:

$$ME ( s , c ) = {\sum }_{b}^{b ⋐ s} ME ( s , c , b ) \qquad ( 1 )$$

Some of the blocks are completely comprised by one of the segments, e.g. the blocks b11, b12, b13, b21, b22, b23, b31, b32, b33 and b41 are comprised by segment S11. It will be clear that in that case the partial match errors ME(s,c,b) of these blocks contribute to segment S11. However there are also blocks which correspond with multiple segments. E.g. block b14 is partly located inside segment S11 and partly located inside segment S12. There are a number of approaches to deal with these type of blocks. These approaches will be explained below by means of examples.

The first approach is based on splitting each of the blocks that overlaps with multiple segments, into a number of groups of pixels. FIG. 2 schematically shows a detail of FIG. 1. More particular, block b24 is depicted. It is shown that this block b24 comprises a first group of pixels 202 which corresponds to segment S11 and a second group of pixels 204 which corresponds to segment S12. For the first group of pixels 202 candidate motions vectors of segment S11 have to be evaluated and for the second group of pixels 204 candidate motions vectors of segment S12 have to be evaluated. Notice that some of the candidate motion vectors of segment S11 might be equal to some of the candidate motion vectors of segment S12. However, the probability is high that there are also differences between the sets of candidate motion vectors. Hence, for the first group of pixels 202 a number of partial match errors ME(SL11,c,b24(1)) are computed and for the second group of pixels 202 a number of partial match errors ME(S12,c,b24(2)) are computed. In this case the first group of pixels 202 of block b24 is denoted as b24(1) and case the second group of pixels 204 of block b24 is denoted as b24(2). The match errors of the various candidate motion vectors of segment S11 are computed by accumulation of the partial match errors which are partly or completely comprised by segment S11.
ME(S11,c)=ME(S11,c,b11)+ME(S11,c,b12)+ME(S11,c,b13)+ME(S11, c,b14(1))+ME(S11,c,b21)+ME(S11,c,b22)+ME(S11,c,b23)+ME(S11,c,b24(1))+ME(S11,c,b31)+ME(S11,c,b32)+ME(S11, c,b33)+ME(S11,c,b34(1))+ME(S11,c,b41 )+ME(S11,c,b42(1))+ME(S11,c,b43(1))+ME(S11,c,b44(1))+ME(S11,c,b51(1))+ME(S11,c,b52(1)) (2)
After the accumulation of the partial match errors, for each of the candidate motion vectors the corresponding match error is known. The candidate motion vector MV (S11,c) with the lowest match error is selected as the motion vector MV(S11) for the segment S11.

The second approach is also based on splitting each of the blocks that overlaps with multiple segments, into a number of groups of pixels. However, if the number of pixels of a group is less then a predetermined threshold, then no partial motion vector is computed for that group of pixels. The threshold is e.g. ½ or ¼ of the number of pixels of the block. E.g. in the example as illustrated in FIG. 1 that means that for the computation of the match errors of the candidate motion vectors of segment S1 there are no contributions of the blocks b44 and b52 if the threshold equals ¼ of the number of pixels of the block. For groups of pixels comprising more pixels than the predetermined threshold, partial motion vectors are being computed and accumulated as described above.

In the third approach, determining which of the candidate motion vectors belong to the blocks, is based on the amount of overlap between segments and the blocks within the segmented image. That means that if a particular block is overlapped by multiple segments, then partial match errors are computed on basis of all pixels of that particular block and based on the candidate motion vectors of the segment with the largest overlap with the particular block. E.g. in the example as illustrated in FIG. 1 that means that for the computation of the match errors of the candidate motion vectors of segment S1 the following blocks fully contribute to segment S1: b14, b24 and b34. Optionally, it is tested whether the largest overlap is bigger than a predetermined threshold. That is particularly relevant in the case that a block is overlapped by more than two segments. If the largest overlap is less than a predetermined threshold then no partial match errors are computed for that block.

In the fourth approach, no partial match errors are computed at all for those blocks which overlap with multiple segments. In other words, from those blocks there are no contributions for the candidate motion vector evaluation. E.g. in the example as illustrated in FIG. 1 that means that for the computation of the match errors of the candidate motion vectors of segment S1 only the following blocks contribute: b11, b12, b13, b21, b22, b23, b31, b32, b33 and b41.

It should be noted that although FIG. 1 shows two segmented images 100 and 102, in fact only one segmentation is required. That means that the other image does not have to be segmented. That is an advantage of the method according to the invention. Because the actual computations are block-based and the optional division of blocks into groups is based on the segments of one segmented image only.

FIG. 3 schematically shows an embodiment of the motion estimation unit 300 according to the invention. The motion estimation unit 300 is provided with images, i.e. pixel values at input connector 316 and with segmentation data, e.g. a mask per image or description of contours enclosing the segments per image, at the input connector 318. The motion estimation unit 300 provides per segment a motion vector at the output connector 320. The motion estimation unit 300 is arranged to estimate motion vectors as explained in connection with FIG. 1. The motion estimation unit 300 comprises:

a creating unit 314 for creating sets of candidate motion vectors for the respective segments of a segmented image;

a dividing unit 304 for dividing the segmented image into a grid of blocks of pixels. The dividing unit 304 is arranged to access from the memory device 302 those pixel values which belong to a block of pixels under consideration. Alternatively, the dividing unit 304 is arranged to determine coordinates and leaves the access of pixel values on basis of the coordinates to other units of the motion estimation unit 300. The memory device 302 can be part of the motion estimation unit 300 but it might also be shared with other units or modules of the image processing apparatus, e.g. a segmentation unit 502 or an image processing unit 504 being controlled by the motion estimation unit 300;

a determining unit 306 for determining for the blocks of pixels which of the candidate motion vectors belong to the blocks, on basis of the segments and the locations of the blocks within the segmented image;

a computing unit 308 for computing partial match errors for the blocks on basis of the determined candidate motion vectors and on basis of pixel values of a further image;

a combining unit 310 for combining the partial match errors into a number of match errors per segment;

a selecting unit 312 for selecting for each of the sets of candidate motion vectors respective candidate motion vectors on basis of the match errors and for assigning the selected candidate motion vectors as the motion vectors for the respective segments.

The working of the motion estimation unit 300 is as follows. See also FIG. 1. It is assumed that the image 100 is segmented into four segments S11-S14 and that initially for each of the segments there is only one candidate motion vector. These candidate motion vectors CMV (*,*) are generated by means of the creating unit 314 and provided to the determining unit 306.

The dividing unit 304 is arranged to access the memory device such that the pixel values of image 100 are accessed block by block in a scanning scheme from the left top to the right bottom, i.e. from block b11 to block b 88. The dividing unit 304 provides for each block e.g. b11 the corresponding (x,y) coordinates to the determining unit 306. The determining unit 306 is arranged to determine for each of the blocks of pixels which of the candidate motion vectors belong to the blocks on basis of the coordinates and on basis of the locations of the segments.

The first block b11 is completely overlapped by the first segment S11. So, only the candidate motion vector of segment S1, CMV (S11, C1), is provided to the computing unit 308. On basis of the candidate motion vector CMV (S11, C1) and on basis of the coordinates of block b11 the computing unit is arranged to access pixel values of the further image 102. Subsequently a partial match error ME (S11, C1, b11) for the block is computed and provided to the combining unit 310. For the blocks b12 and b13 similar processing steps are performed resulting in partial match errors ME(S11, C1, b12) and ME(S11, C1, b13), respectively.

The fourth block b14 is partly overlapped by the first segment S11 and partly overlapped by the second segment S12. So, two candidate motion vectors CMV (S11, C1) and CMV(S12, C1) are provided to the computing unit 308. The computing unit 308 is arranged to access pixel values of the further image 102 on basis of:

the candidate motion vectors CMV (S11, C1) and CMV (S12, C1);

the segmentation data; and

the coordinates of block b11.

Subsequently two partial match errors ME(S11, C1, b14(1)) and ME(S12, C1, b14(2)) for the two groups of pixels b14(1) and b14(2) of block b14 are computed and provided to the combining unit 310.

The above described processing steps are performed for all blocks in a similar way. After all partial match errors are computed, the match errors per segment can be established. It will be clear that the computation and accumulation of partial match errors can be done in parallel.

Then for each of the segments a new candidate motion vector is generated. Preferably, these new candidate motion vectors are derived from sets of candidates of other segments. For these new candidates also the corresponding match errors are computed. After all match errors of the candidate motion vectors have been computed, the selecting unit 312 selects per segment the candidate motion vector with the lowest match error.

Above it is described that the generation and evaluation of candidate motion vectors are performed alternatingly. Alternatively, the generation and evaluation are performed subsequently, i.e. first all candidate motion vectors are generated and then evaluated. Alternatively, first a portion of candidate motion vectors is generated and evaluated and after that a second portion of candidate motion vectors is generated and evaluated.

Above it is described that for a particular block only one candidate motion vector per overlapping segment is evaluated. After that a next block is being processed. Alternatively, all available candidate motion vectors for a particular block are evaluated and subsequently all available candidate motion vectors for a next block are evaluated.

The creating unit 314, the dividing unit 304, the determining unit 306, the computing unit 308, the combining unit 310 and the selecting unit 312 may be implemented using one processor. Normally, these functions are performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

Above it is described that the processing is performed in a scanning scheme, row-by-row. Alternatively the processing is performed in parallel for a number of rows simultaneously. After a first iteration over the image, typically an additional number of iterations will be performed over the image. Preferably, the scanning scheme is different for the subsequent iterations, e.g. row-by-row, column-by-column, zigzag. The process stops after a predetermined number of iterations or when convergence is achieved.

Although iterations over the entire image result into appropriate results, it is preferred, from a memory bandwidth usage point of view, to split the process of estimating motion vectors for the respective segments into sub-processes of estimating intermediate motion vectors for sub-segments, followed by a post-processing step of combining the results of the sub-processes. FIG. 4 schematically shows one of the segmented images 100 of FIG. 1 and the four sub-images 401-404 forming that segmented image 100. The first sub-image 401 corresponds with the blocks b11-b28. The second sub-image 402 corresponds with the blocks b31-b48. The third sub-image 403 corresponds with the blocks b51-b68. The fourth sub-image 404 corresponds with the blocks b71-b88. The first sub-image 401 overlaps with a first part, i.e. sub-segment S111 of the segment S11 as depicted in FIG. 1 and the first sub-image 401 overlaps with a second part, i.e. sub-segment S121 of the segment S12 as depicted in FIG. 1. The second sub-image 402 overlaps with a first part, i.e. sub-segment S112 of the segment S11, with a second part, i.e. sub-segment S122 of the segment S12, with a third part, i.e. sub-segment 132 of the segment S13 and with a fourth part, i.e. sub-segment S142 of the segment S14. The third sub-image 403 overlaps with a first part, i.e. sub-segment S133 of the segment S13 and with a second part, i.e. sub-segment S143 of the segment S14. The fourth sub-image 404 overlaps with a first part, i.e. sub-segment S134 of the segment S13 and with a second part, i.e. sub-segment S144 of the segment S14.

First initial motion vectors MV(SL11)-MV(S144) are estimated for the sub-segments S111-S144, respectively. This is performed similar as described in connection with the FIGS. 1-3, albeit in the context of the specified sub-images. The estimation of the initial motion vectors MV (SL11)-MV (S144) might be performed sequentially, i.e. sub-image after sub-image. However, preferably the estimation of the initial motion vectors MV(S11)-MV (S144) is performed in parallel. After the initial motion vectors MV (S111)-MV (S144) are determined the final motion vectors MV (SL11)-MV(S14) for the respective segments S11-S14 of the segmented image 100 are established. E.g. a final motion vector MV (S12) for segment S12 is determined on basis of a first motion vector MV (S121) being determined for sub-segment S121 and a second motion vector MV (S122) being determined for sub-segment S122. In many cases, it appears that the first motion vector MV (S121) and the second motion vector MV (S122) are mutually equal. The establishing of the final motion vector for segment S12 is relatively easy then, i.e. selecting one or the other. In the case of a discrepancy between the first motion vector MV (S121) and the second motion vector MV (S122) it is preferred to select the initial motion vector which has the biggest overlap with segment S12. In this case, the first motion vector MV (S121) is assigned as the final motion vector MV (S12) for segment S12 because a first size of the first sub-segment S121 is larger than a second size of the sub-segment S122.

Next, another example of establishing a final motion vector MV (S13) corresponding to a segment S13 which overlaps with three sub-segments S132, S133 and S134 is discussed. First the amounts of overlap of the different sub-segments S132, S133 and S134 with segment S13 are determined. This is done by counting the respective number of pixels being located within the respective portions of the contour representing the segment S13 and the borders of the sub-images 402, 403 and 404, intersecting the contour. In this case, the first size of sub-segment S132 is relatively low. Because of that, the corresponding initial motion vector MV (S132) is not taken into account for the computation of the final motion vector MV (S13) of segment S13. The final motion vector MV (S13) of segment S13 is based on an weighted average of the initial motion vectors MV (S133) and MV (S134) being determined for the sub-segments S133 and S134, respectively. The weighting coefficients are based on the respective amounts of overlap of the sub-segments S133 and S134.

FIG. 5 schematically shows an image processing apparatus according to the invention, comprising:

A segmentation unit 502 for segmenting input images into a segmented images. The segmentation unit 502 is arranged to receive a signal representing the input images. The signal may be a broadcast signal received via an antenna or cable but may also be a signal from a storage device like a VCR (Video Cassette Recorder) or Digital Versatile Disk (DVD). The signal is provided at the input connector 510;

The segment-based motion estimation unit 508 as described in connection with FIG. 3;

An image processing unit 504 being controlled by the motion estimation unit 508. The image processing unit 504 might support one or more of the following types of image processing: video compression, de-interlacing, image rate conversion, or temporal noise reduction.

A display device 506 for displaying the output images of the image processing unit 504.

The image processing apparatus 500 might e.g. be a TV. Alternatively the image processing apparatus 500 does not comprise the optional display device 506 but provides the output images to an apparatus that does comprise a display device 506. Then the image processing apparatus 500 might be e.g. a set top box, a satellite-tuner, a VCR player, a DVD player or recorder. Optionally the image processing apparatus 500 comprises storage means, like a hard-disk or means for storage on removable media, e.g. optical disks. The image processing apparatus 500 might also be a system being applied by a film-studio or broadcaster.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A method of segment-based motion estimation to determine motion vectors for respective segments (S11-S14) of a segmented image (100), the method comprising:
creating sets of candidate motion vectors for the respective segments (S11-S14);
dividing the segmented image (100) into a grid of blocks (b11-b88) of pixels;
determining for the blocks (b11-b88) of pixels which of the candidate motion vectors belong to the blocks (b11-b88), on basis of the segments (S11-S14) and the locations of the blocks (b11-b88) within the segmented image (100);
computing partial match errors for the blocks (b11-b88) on basis of the determined candidate motion vectors and on basis of pixel values of a further image (102);
combining the partial match errors into a number of match errors per segment;
selecting for each of the sets of candidate motion vectors respective candidate motion vectors on basis of the match errors; and
assigning the selected candidate motion vectors as the motion vectors for the respective segments (S11-S14).

2. A method of segment-based motion estimation as claimed in claim 1, further comprising:
splitting each block of a portion of the blocks (b11-b88) into respective groups of pixels on basis of the segments (S11-S14) and the locations of the blocks (b11-b88) within the segmented image (100), each block of the portion of the blocks (b11-b88) overlapping with multiple segments (S11-S14);
determining for the groups of pixels which of the candidate motion vectors belong to the groups of pixels, on basis of the segments (S11-S14) and the locations of the groups of pixels within the segmented image (100);
computing further partial match errors for the groups of pixels on basis of the determined candidate motion vectors and on basis of the pixel values of the further image (102); and
combining the partial match errors and the further partial match errors into a number of match errors per segment.

3. A method of segment-based motion estimation as claimed in claim 1, whereby determining for the blocks (b11-b88) of pixels which of the candidate motion vectors belong to the blocks (b11-b88), is based on the amount of overlap between segments (S11-S14) and the blocks (b11-b88) within the segmented image (100).

4. A method of segment-based motion estimation as claimed in claim 1, whereby a first one of the partial match errors corresponds with the sum of differences between pixel values of the segmented image (100) and further pixel values of the further image (102).

5. A method of segment-based motion estimation as claimed in claim 1, whereby a first one of the blocks (b11-b88) of pixels comprises 8*8 or 16*16 pixels.

6. A method of segment-based motion estimation as claimed in claim 1, further comprising:
determining a final motion vector on basis of a first one of the motion vectors, being assigned to a first one of the segments, and on basis of a particular motion vector, being assigned to a further segment of a further segmented image, the segmented image and the further segmented image being both part of a single extended image, the first one of the segments and the further segment being both part of a single segment which extends over the segmented image and the further segmented image; and
assigning the final motion vector to the first one of the segments.

7. A method of segment-based motion estimation as claimed in claim 6, whereby the first one of the motion vectors is assigned as the final motion vector if a first size of the first one of the segments is larger than a second size of the further segment and, whereby the particular motion vector is assigned as the final motion vector if the second size is larger than the first size.

8. A motion estimation unit (300) for estimating motion vectors for respective segments (S11-S14) of a segmented image (100), the motion estimation unit comprising:
creating means (314) for creating sets of candidate motion vectors for the respective segments (S11-S14);
dividing means (304) for dividing the segmented image (100) into a grid of blocks (b11-b88) of pixels;
determining means (306) for determining for the blocks (b11-b88) of pixels which of the candidate motion vectors belong to the blocks (b11-b88), on basis of the segments (S11-S14) and the locations of the blocks (b11-b88) within the segmented image (100);
computing means (308) for computing partial match errors for the blocks (b11-b88) on basis of the determined candidate motion vectors and on basis of pixel values of a further image (102);
combining means (310) for combining the partial match errors into a number of match errors per segment;
selecting means (312) for selecting for each of the sets of candidate motion vectors respective candidate motion vectors on basis of the match errors; and
assigning means for assigning the selected candidate motion vectors as the motion vectors for the respective segments (S11-S14).

9. An image processing apparatus (500) comprising:
a segmentation unit (502) for segmenting an input image into a segmented image (100); and
a motion estimation unit (508) for estimating motion vectors for respective segments (S11-S14) of the segmented image (100), as claimed in claim 6.

10. An image processing apparatus (500) as claimed in claim 9, characterized in further comprising processing means being controlled (504) on basis of the motion vectors.

11. An image processing apparatus (500) as claimed in claim 10, characterized in that the processing means (504) are arranged to perform video compression.

12. An image processing apparatus (500) as claimed in claim 10, characterized in that the processing means (504) are arranged to perform de-interlacing.

13. An image processing apparatus (500) as claimed in claim 10, characterized in that the processing means (504) are arranged to perform image rate conversion.

14. An image processing apparatus (500) as claimed in claim 9, characterized in that it is a TV.
